(19) United States
(12) Patent Application Publication
(10) Pub. No.: US 2017/0228338 A1
(43) Pub. Date: Aug. 10, 2017

(54) SEMICONDUCTOR DEVICE AND ITS CONTROL METHOD

(71) Applicant: Renesas Electronics Corporation, Tokyo (JP)

(72) Inventor: Yoshifumi IKENAGA, Tokyo (JP)

(21) Appl. No.: 15/502,767

(22) PCT Filed: Nov. 14, 2014
(86) PCT No.: PCT/JP2014/005738

§ 371 Date: Feb. 8, 2017

(51) Int. Cl. G06F 13/40

(52) U.S. Cl. CPC G06F 13/4072; G06F 13/4022

(57) ABSTRACT

A semiconductor device (1) according to the present invention includes a plurality of buses (B1 to Bm), a control unit (10) connected to the plurality of buses (B1 to Bm), the control unit (10) being configured to acquire information about a communication specification including information about a drive voltage from each of a plurality of externally-disposed modules (M1 to Mn) through one of the plurality of buses (B1 to Bm), and a switch circuit (13) configured to set a connection between the plurality of modules (M1 to Mn) and the plurality of buses (B1 to Bm) based on the information about the communication specification for each of the plurality of modules (M1 to Mn) acquired by the control unit (10).

### TECHNICAL FIELD

The present invention relates to a semiconductor device and its control method. For example, the present invention relates to a semiconductor device and its control method suitable for improving flexibility in design.

### BACKGROUND ART

An I2C (Inter-Integrated Circuit) communication method has been widely used for data communication between a controller and a module. In the I2C communication, since a controller can be connected to a plurality of modules through a common bus, the number of signal lines can be reduced.

Examples of the module include a sensor, a liquid crystal display, and the like. Note that there are modules having different communication speeds and different drive voltages (supply voltages). The controller needs to supply a drive voltage that is specified in a communication specification and supported by a module with which the controller communicates, and perform communication with the module at a communication speed and a drive voltage (a signal amplitude) that are supported by that module.

Patent Literature 1 discloses a programmable controller system including a programmable controller and at least two modules having different operating speeds, in which the modules are connected to a common extension bus and a common I2C bus. When the programmable controller performs data communication with a module, it sends an ID of that module to the I2C bus. When the sent ID indicates its own module, that module performs data communication with the programmable controller through the extension bus. The programmable controller performs the data communication with the module in a bus cycle corresponding to the ID of that module.

### CITATION LIST

### Patent Literature

Patent Literature 1: Japanese Unexamined Patent Application Publication No. 2010-3041

### SUMMARY OF INVENTION

### Technical Problem

However, the configuration disclosed in Patent Literature 1 does not take data communication between the controller and a plurality of modules having different drive voltages into consideration. Therefore, in the configuration disclosed in Patent Literature 1, it is impossible to perform data communication in a state where the controller is connected with a plurality of modules having different drive voltages at the same time. As described above, there is a problem in the configuration disclosed in Patent Literature 1 that flexibility in design cannot be improved. Other objects and novel features will be more apparent from the following description in the specification and the accompanying drawings.

### Solution to Problem

According to one embodiment, a semiconductor device includes: a plurality of buses; a control unit connected to the plurality of buses, the control unit being configured to acquire information about a communication specification including information about a drive voltage from each of a plurality of externally-disposed modules through one of the plurality of buses; and a switch circuit configured to set a connection between the plurality of modules and the plurality of buses based on the information about the communication specification for each of the plurality of modules acquired by the control unit.

Further, according to another embodiment, a control method for a semiconductor device includes: acquiring information about a communication specification including information about a drive voltage from each of a plurality of externally-disposed modules; setting a connection between the plurality of modules and a plurality of buses based on the communication specification for each of the plurality of modules; and performing data communication with the plurality of modules through the plurality of buses.

According to the above-described circuit configuration, it is possible to improve flexibility in design.

### Advantageous Effects of Invention

According to the above-described embodiment, it is possible to provide a semiconductor device and its control method capable of improving flexibility in design.

### BRIEF DESCRIPTION OF DRAWINGS

FIG. 1 is a block diagram showing a configuration of a semiconductor system including a semiconductor device according to a first embodiment;

FIG. 2 shows a structure example of registers provided in the semiconductor device shown in FIG. 1;

FIG. 3 is a schematic view showing a switch circuit provided in the semiconductor device shown in FIG. 1;

FIG. 4 is a circuit diagram showing a specific configuration of a part of a level conversion circuit provided in the semiconductor device shown in FIG. 1;

FIG. 5 shows a specific configuration of a specification detection circuit provided in the semiconductor device shown in FIG. 1;

FIG. 6 is a flowchart showing a connection setting operation performed by the semiconductor device shown in FIG. 1;

FIG. 7 shows values that are stored in a register during the connection setting operation performed by the semiconductor device shown in FIG. 1;

FIG. 8 shows values that are stored in a register during the connection setting operation performed by the semiconductor device shown in FIG. 1;

FIG. 9 shows values that are stored in a register during the connection setting operation performed by the semiconductor device shown in FIG. 1;

FIG. 10 shows values that are stored in a register during the connection setting operation performed by the semiconductor device shown in FIG. 1;

FIG. 11 shows values that are stored in a register during the connection setting operation performed by the semiconductor device shown in FIG. 1;

FIG. 12 shows values that are stored in a register during the connection setting operation performed by the semiconductor device shown in FIG. 1;

FIG. 13 is a block diagram showing a configuration of a semiconductor system including a semiconductor device according to a second embodiment;

FIG. 14 is a flowchart showing a connection setting operation performed by the semiconductor device shown in FIG. 13;

FIG. 15 is a block diagram showing a configuration of a semiconductor system including a semiconductor device according to a third embodiment; and

FIG. 16 is a flowchart showing a connection setting operation performed by the semiconductor device shown in FIG. 15.

### DESCRIPTION OF EMBODIMENTS

Embodiments are explained hereinafter with reference to the drawings. It should be noted that the drawings are made in a simplified manner, and therefore the technical scope of the embodiments should not be narrowly interpreted based on those drawings. Further, the same components are assigned the same symbols and their duplicated explanations are omitted.

In the following embodiments, when necessary, the present invention is explained by using separate sections or separate embodiments. However, those embodiments are not unrelated with each other, unless otherwise specified. That is, they are related in such a manner that one embodiment is a modified example, an application example, a detailed example, or a supplementary example of a part or the whole of another embodiment. Further, in the following embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may be also used.

Further, in the following embodiments, their components (including operation steps and the like) are not necessarily indispensable except for cases where the component is explicitly specified or the component is obviously indispensable based on its principle. Similarly, in the following embodiments, when a shape, a position relation, or the like of a component(s) or the like is mentioned, shapes or the likes that are substantially similar to or resemble that shape are also included in that shape except for cases where it is explicitly specified or they are eliminated based on its principle. This is also true for the above-described number or the like (including numbers, values, quantities, ranges, and the like).

### First Embodiment

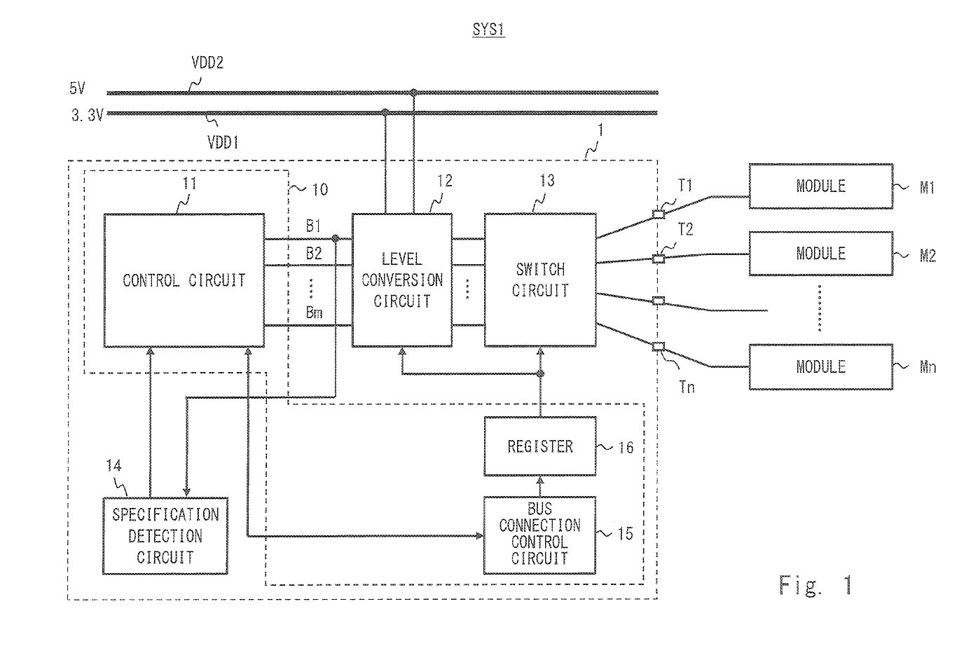

FIG. 1 is a block diagram showing a configuration of a semiconductor system SYS1 including a semiconductor device 1 according to a first embodiment. The semiconductor device 1 according to this embodiment acquires information about a communication specification (or a communication standard) including information about a drive voltage from each of a plurality of externally-disposed modules, sets (or establishes) a connection between the plurality of modules and a plurality of buses based on the communication specification for each of the plurality of modules, and then performs data communication with the plurality of modules through the plurality of buses. The semiconductor device 1 according to this embodiment can connect a plurality of modules having different drive voltages as well as a plurality of modules having different communication speeds to a control circuit at the same time, thus making it possible to simultaneously control the plurality of modules having difference drive voltages and/or different communication speeds by using one control circuit. That is, it is possible to improve flexibility in design. Explanations are given hereinafter in a concrete manner.

As shown in FIG. 1, the semiconductor system SYS1 includes the semiconductor device 1 and modules M1 to Mn (n is an integer no less than two).

The semiconductor device 1 is composed of one or a plurality of chips, and includes a plurality of buses B1 to Bm (m is an integer no less than two), a control circuit 11, a level conversion circuit 12, a switch circuit 13, a specification detection circuit 14, a bus connection control circuit 15, and a register(s) 16. Note that the control circuit 11, the bus connection control circuit 15, and the register 16 form a control unit (controller) 10. The control unit 10 is, for example, a microcomputer.

The control circuit 11 is connected to the switch circuit 13 though the buses B1 to Bm with the level conversion circuit 12 interposed therebetween. The switch circuit 13 is connected to the modules M1 to Mn through connectors T1 to Tn.

### (Control Circuit 11)

The control circuit 11 is a circuit that performs data communication with the modules M1 to Mn through the plurality of buses B1 to Bm. Note that the control circuit 11 has a function of performing communication at the same communication speed as that of each of the modules. This embodiment is explained by using an example case where the I2C method is adopted as a method for data communication between the control circuit 11 and the modules M1 to Mn. Therefore, each of the buses B1 to Bm includes at least a power supply line, a ground line, a clock signal line SCL, and a data signal line SDA.

Further, the control circuit 11 acquires, before a normal operation, information about a communication specification (hereinafter also referred to as “communication specification information”) including information about a drive voltage from each of the modules M1 to Mn directly or through the specification detection circuit 14 and outputs the acquired information to the bus connection control circuit 15. How the control circuit 11 acquires the information about the communication specification of each module will be explained later.

### (Bus Connection Control Circuit 15 and Register 16)

The bus connection control circuit 15 rewrites a value(s) in the register 16 based on an instruction from the control circuit 11.

For example, when the communication specification information about each of the modules M1 to Mn is acquired, the bus connection control circuit 15 rewrites a value(s) in the register 16 by using the switch circuit 13 so that the modules M1 to Mn are connected to the bus B1 one by one in an orderly manner. Further, at this point, the bus connection control circuit 15 also writes information about a voltage and a communication speed that are assigned to the bus B1 into the register 16. Further, every time information about a communication specification of one of the modules M1 to Mn is acquired, the bus connection control circuit 15 writes that information about the communication specification into the register 16. After the communication specification information about all of the modules M1 to Mn is acquired, the bus connection control circuit 15 rewrites information about the communication specification assigned to each of the buses B1 to Bm and information about connections between the buses B1 to Bm and the modules M1 to Mn (i.e., information about the on/off state of each switch SW (which will be described later)) based on the acquired communication specification information.

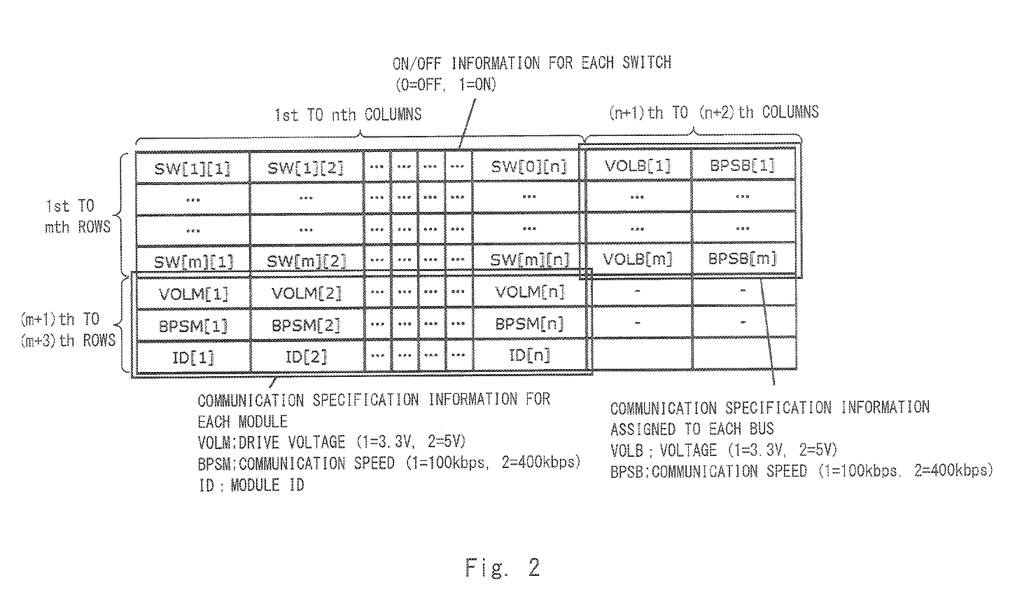

FIG. 2 shows an example of a structure of the register 16.

As shown in FIG. 2, a plurality of storage areas are arranged in a matrix pattern in the register 16.

Information about on/off states of a plurality of switches SWs (which will be described later) arranged in a matrix pattern between the buses B1 to Bm and the modules M1 to Mn is stored in storage areas in (1st to mth rows)×(1st to nth columns) in the register 16. In the example shown in FIG. 2, SW[j][k] (j is a natural number between 1 and m, and k is a natural number between 1 and n) represents information about a switch SW disposed between a bus Bj and a module Mk. Note that in this example, when the value of SW[j][k] is 0, the switch SW disposed between the bus Bj and the module Mk is turned off. On the other hand, when the value of SW[j][k] is 1, the switch SW disposed between the bus Bj and the module Mk is turned on.

Communication specification information about the modules M1 to Mn is stored in storage areas in (m+1)th to (m+3)th rows in the register 16.

Specifically, information about drive voltages for the modules M1 to Mn is stored in storage areas in the (m+1)th row. In the example shown in FIG. 2, VOLM[k] represents information about a drive voltage of a module Mk. Note that in this example, when the value of VOLM[k] is 1, it indicates that the drive voltage of the module Mk is 3.3 V. Further, when the value of VOLM[k] is 2, it indicates that the drive voltage of the module Mk is 5 V.

Information about communication speeds of the modules M1 to Mn is stored in storage areas in the (m+2)th row. In the example shown in FIG. 2, BPSM[k] represents information about a communication speed of a module Mk. Note that in this example, when the value of BPSM[k] is 1, it indicates that the communication speed of the module Mk is 100 kbps. Further, when the value of BPSM[k] is 2, it indicates that the communication speed of the module Mk is 400 kbps.

Information about module IDs of the modules M1 to Mn is stored in storage areas in the (m+3)th row. In the example shown in FIG. 2, ID[k] represents information about a module ID of a module Mk.

Information about communication specifications assigned to buses B1 to Bm is stored in storage areas in (n+1)th and (n+2)th columns in the register 16.

Specifically, information about drive voltages assigned to the buses B1 to Bm is stored in storage areas in the (n+1)th column. In the example shown in FIG. 2, VOLB[j] represents information about a drive voltage assigned to a bus Bj. Note that in this example, when the value of VOLB[j] is 1, it indicates that the drive voltage assigned to the bus Bj is 3.3 V. Further, when the value of VOLB[j] is 2, it indicates that the drive voltage assigned to the bus Bj is 5 V.

Information about communication speeds assigned to buses B1 to Bm is stored in storage areas in the (n+2)th column. In the example shown in FIG. 2, BPSB[j] represents information about a communication speed assigned to a bus Bj. Note that in this example, when the value of BPSB[j] is 1, it indicates that the communication speed assigned to the bus Bj is 100 kbps. Further, when the value of BPSB[j] is 2, it indicates that the communication speed assigned to the bus Bj is 400 kbps.

### (Switch Circuit 13)

The switch circuit 13 sets (or establishes) connections between the buses B1 to Bm and the modules M1 to Mn based on values in the register 16. For example, as described above, when the communication specification information of each of the modules M1 to Mn is acquired, the switch circuit 13 connects the modules M1 to Mn to the bus B1 one by one in an orderly manner. In contrast to this, after the communication specification information of each of the modules M1 to Mn is acquired, the switch circuit 13 connects a plurality of modules having the same communication specification to the same bus based on the information about connections between the buses B1 to Bm and the modules M1 to Mn stored in the register 16. Specifically, the switch circuit 13 connects a plurality of modules having the same communication speed and the same drive voltage to the same bus

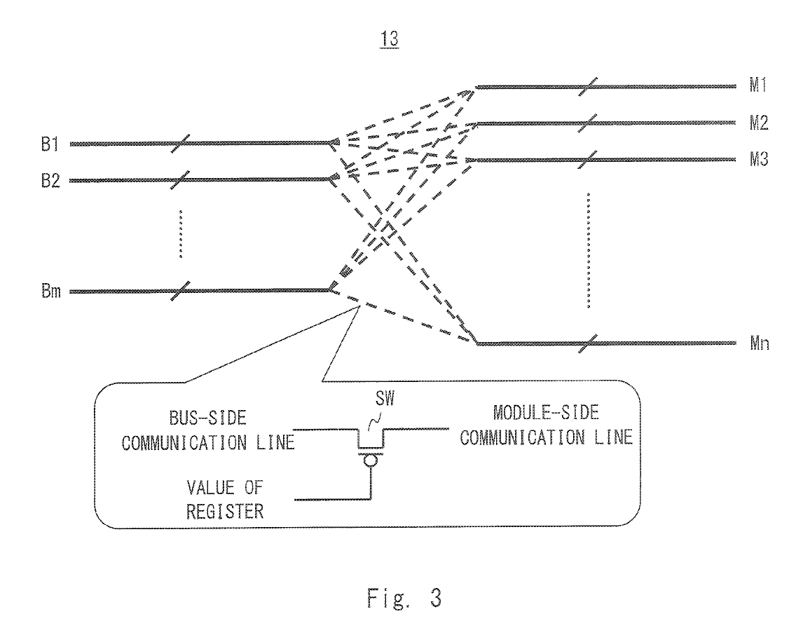

FIG. 3 is a schematic view showing the switch circuit 13.

As shown in FIG. 3, the switch circuit 13 includes a plurality of switches SWs arranged in a matrix pattern between the buses B1 to Bm and the modules M1 to Mn. Each of the switches SWs is, for example, a P-channel MOS transistor and its on/off state is controlled based on a value in the register 16. In this example, the number of the switches SWs is (m×n×3) (=(the number m of buses)×(the number n of modules)×(the number of communication lines)) (in this example, the number of communication lines is three, i.e., the power supply line, the signal line SCL, and the signal line SDA)).

The switch circuit 13 sets (or establishes) connections between the buses B1 to Bm and the modules M1 to Mn based on the on/off information (SW[j][k]) for each of the switches SWs stored in the storage areas in (1st to mth rows)×(1st to nth columns) in the register 16 shown in FIG. 2. By doing so, a plurality of modules having the same communication specification are connected to the same bus.

### (Level Conversion Circuit 12)

The level conversion circuit 12 supplies drive voltages having levels corresponding to values in the register 16 to the modules M1 to Mn. For example, when the communication specification information of each of the modules M1 to Mn is acquired, the level conversion circuit 12 supplies, as a drive voltage, the minimum voltage at which the modules M1 to Mn can operate alone to one of the modules M1 to Mn through a bus B1 based on information about a voltage that is stored in the register 16 and assigned to the bus B1. In this example, the level conversion circuit 12 supplies, as the drive voltage, the lowest power supply voltage (VDD1), which is 3.3 V, among a plurality of power supply voltages to one of the modules M1 to Mn through the bus B1. In contrast to this, after the communication specification information of each of the modules M1 to Mn is acquired, based on information about voltages that are stored in the register 16 and assigned to the respective buses B1 to Bm, the level conversion circuit 12 supplies, to each of the modules M1 to Mn that is connected to one of the buses B1 to Bm, a drive voltage having a level corresponding to a communication specification for that module.

Further, the level conversion circuit 12 converts the level of a signal that propagates between the control circuit 11 and the modules M1 to Mn.

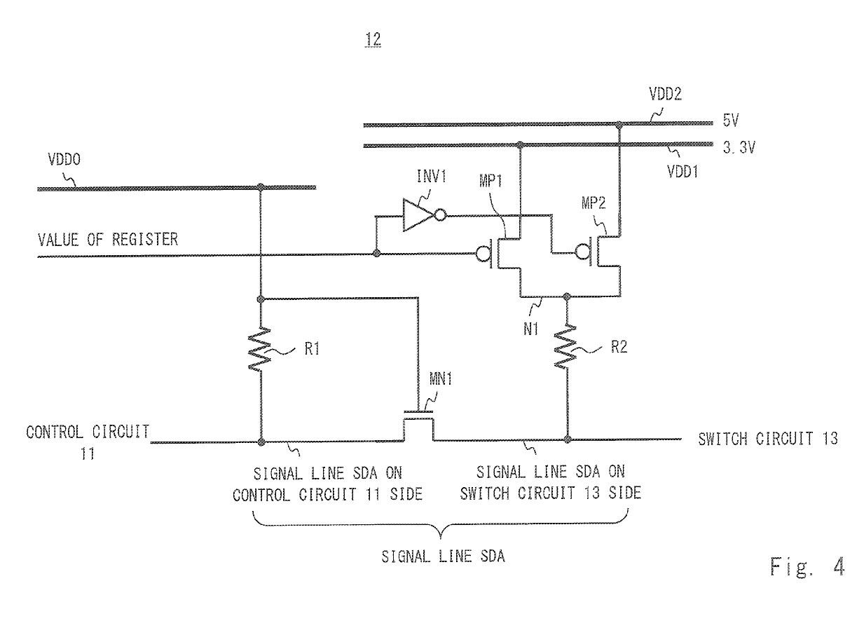

FIG. 4 is a circuit diagram showing a specific configuration of a part of the level conversion circuit 12.

FIG. 4 shows, as an example, a part of the level conversion circuit 12 that is provided for the signal line SDA, which is one of the communication lines included in the bus B1. Note that a similar configuration may be applied to each of the other communication lines (the signal line SCL and the power supply line) included in the bus B1 and each of the communication lines (the signal line SDA, the signal line SCL, and the power supply line) included in each of the other buses B2 to Bn.

As shown in FIG. 4, the level conversion circuit 12 includes, for the signal line SDA of the bus B1, resistive elements R1 and R2, an N-channel MOS transistor (hereinafter simply called a “transistor”) MN1, P-channel MOS transistors (hereinafter simply called “transistors”) MP1 and MP2, and an inverter INV1. A node N1 is provided between the drains of the transistors MP1 and MP2 and the resistive element R1.

The transistor MN1 is disposed on the signal line SDA of the bus B1. Hereinafter, the section of the signal line SDA between the transistor MN1 and the control circuit 11 is referred to as a “signal line SDA on the control circuit 11 side”, and the section of the signal line SDA between the transistor MN1 and the switch circuit 13 is referred to as a “signal line SDA on the switch circuit 13 side”. A power supply having the lowest voltage (hereinafter referred to as a “voltage VDDmin”) among a power supply that supplies a power supply voltage VDD0 to the control circuit 11 (hereinafter referred to as a “voltage VDD0”), a power supply that can supply a drive voltage VDD1 to the modules M1 to Mn (hereinafter referred to as a “voltage VDD1”), and a power supply that can supply a drive voltage VDD2 to the modules M1 to Mn (hereinafter referred to as a “voltage VDD2”) is connected to the gate of the transistor MN1. FIG. 4 shows a connection example where the voltage VDDmin is equal to the voltage VDD0 (VDDmin=VDD0).

The resistive element R1 is disposed between the power supply VDD0 and the signal line SDA on the control circuit 11 side. The resistive element R2 is disposed between the node N1 and the signal line SDA on the switch circuit 13 side. The transistor MP1 is disposed between the power supply VDD1 and the node N1, and its on/off state is controlled according to a value in the register 16. The transistor MP2 is disposed between the power supply VDD2 and the node N1, and controlled so that its on/off state becomes complementary to the on/off state of the transistor MP1.

For example, when information VOLB[1] of a drive voltage that is stored in the register 16 and assigned to the bus B1 is 1, an L-level signal is applied to the gate of the transistor MP1 and an H-level signal is applied to the gate of the transistor MP2. As a result, the transistor MP1 becomes an on-state and the transistor MP2 becomes an off-state. Therefore, the drive voltage VDD1, which is 3.3 V, is supplied to the signal line SDA on the switch circuit 13 side through the transistor MP1 and the resistive element R2. In contrast to this, when information VOLB[1] of the drive voltage that is stored in the register 16 and assigned to the bus B1 is 2, an H-level signal is applied to the gate of the transistor MP1 and an L-level signal is applied to the gate of the transistor MP2. As a result, the transistor MP1 becomes an off-state and the transistor MP2 becomes an on-state. Therefore, the drive voltage VDD2, which is 5 V, is supplied to the signal line SDA on the switch circuit 13 side through the transistor MP2 and the resistive element R2.

In this way, the level conversion circuit 12 supplies drive voltages having levels corresponding to the drive voltage information for the respective buses B1 to Bm (VOLB[1] to VOLB[m]) stored in the (n+1)th column in the register 16 shown in FIG. 2 to the modules M1 to Mn through the buses B1 to Bm.

A level conversion operation performed by the level conversion circuit 12 is explained.

For example, when an H-level signal is transmitted from the control circuit 11 to the switch circuit 13, the H-level signal is applied to the electrode of the transistor MN1 on the control circuit 11 side and an H-level potential (the voltage VDDmin) is applied to the gate of the transistor MN1. As a result, the transistor MN1 becomes an off-state. Consequently, one of the power supply voltages VDD1 and VDD2, i.e., a level-converted H-level signal is supplied to the switch circuit 13 through the resistive element R2. Further, when an L-level signal is transmitted from the control circuit 11 to the switch circuit 13, the L-level signal is applied to the electrode of the transistor MN1 on the control circuit 11 side and an H-level potential (the voltage VDDmin) is applied to the gate of the transistor MN1. As a result, the transistor MN1 becomes an on-state. Consequently, an L-level signal is supplied to the switch circuit 13.

In contrast to this, when an H-level signal is transmitted from one of the modules to the control circuit 11 through the switch circuit 13, the H-level signal is applied to the electrode of the transistor MN1 on the switch circuit 13 side and an H-level potential (the voltage VDDmin) is applied to the gate of the transistor MN1. As a result, the transistor MN1 becomes an off-state. Consequently, the power supply voltage VDD0, i.e., a level-converted H-level signal is supplied to the control circuit 11 through the resistive element R1. Further, when an L-level signal is transmitted from one of the modules to the control circuit 11 through the switch circuit 13, the L-level signal is applied to the electrode of the transistor MN1 on the switch circuit 13 side and an H-level potential (the voltage VDDmin) is applied to the gate of the transistor MN1. As a result, the transistor MN1 becomes an on-state. Consequently, an L-level signal is supplied to the control circuit 11.

### (Specification Detection Circuit 14)

The specification detection circuit 14 is a circuit that detects (i.e., obtains) information about a communication specification output from each of the modules M1 to Mn and outputs the detected information to the control circuit 11 before a normal operation.

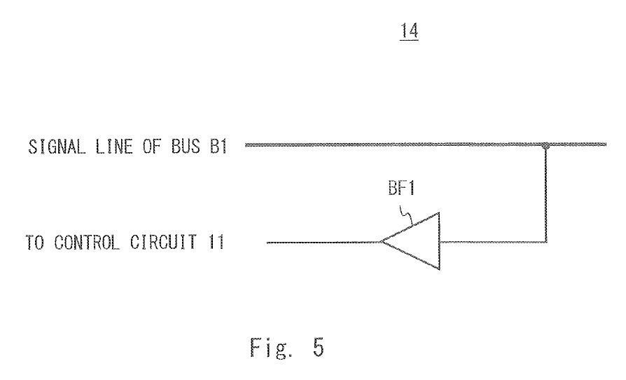

FIG. 5 shows a specific configuration of the specification detection circuit 14.

As shown in FIG. 5, the specification detection circuit 14 includes, for example, a buffer BF1. When the communication specification information of each of the modules M1 to Mn is acquired, the buffer BF1 drives information about a communication specification according to which one of the signal lines (the signal line SCL or the signal line SDA) of the bus B1 is propagated (i.e., transmitted) and outputs the driven information to the control circuit 11. Note that when the control circuit 11 directly acquires communication specification information of each of the modules M1 to Mn, the specification detection circuit 14 may not be necessarily provided.

### (Operation of Semiconductor Device 1)

Next, a connection setting operation performed by the semiconductor device 1 is explained.

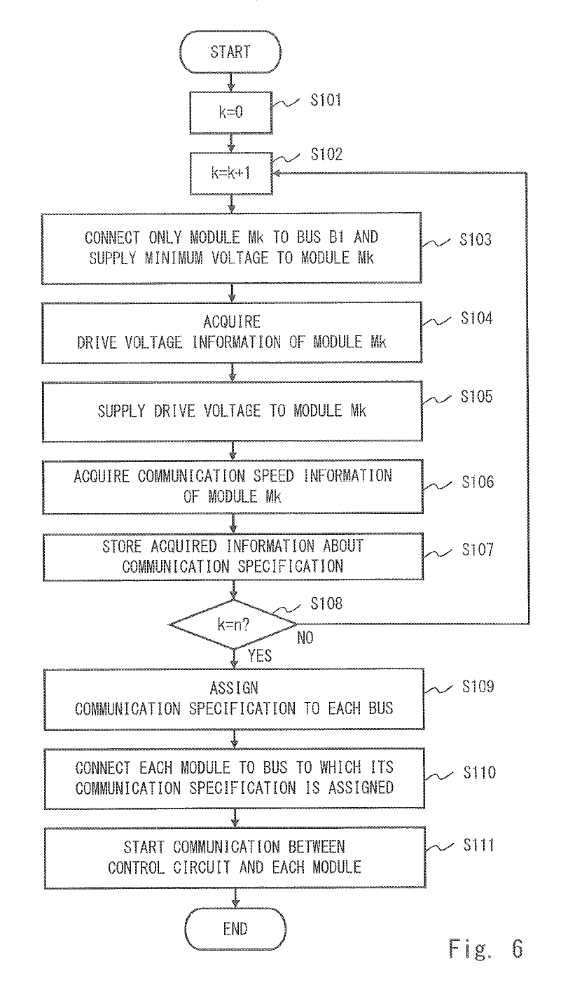

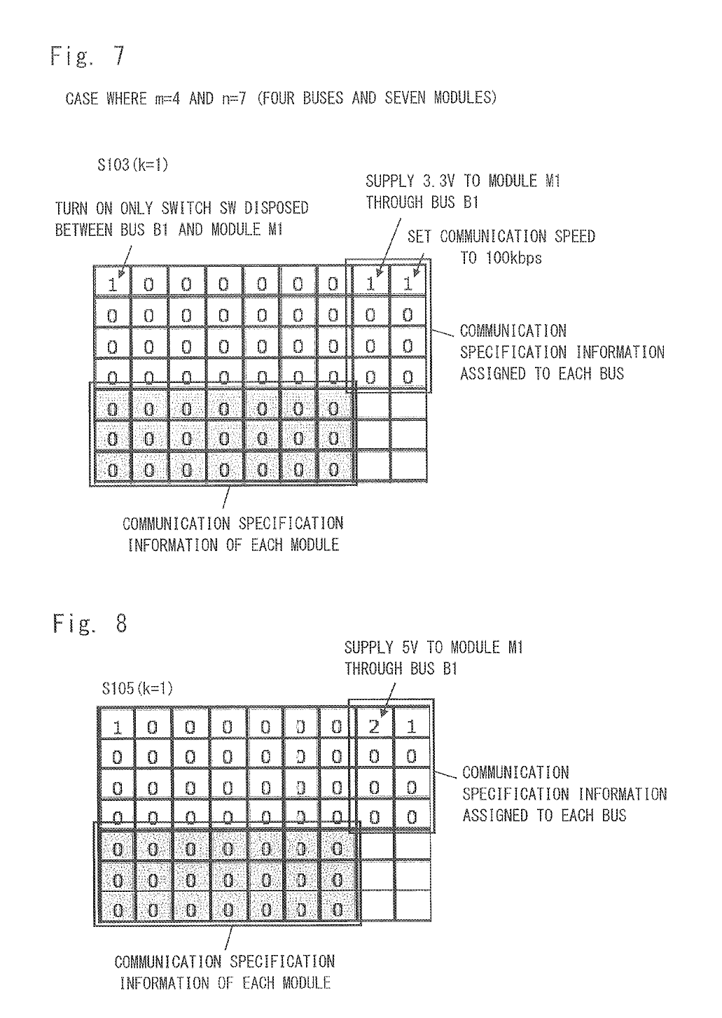

FIG. 6 is a flowchart showing a connection setting operation performed by the semiconductor device 1. Further, FIGS. 7 to 12 show values that are stored in the register 16 during the connection setting operation performed by the semiconductor device 1. In the below explanation, an example case where the number n of modules is seven (n=7) and the number m of buses is four (m=4) is explained.

As shown in FIG. 6, a variable k is set to 0 in an initial state (step S101). After that, the control unit 10 counts up the value of the variable k by one (step S102). Therefore, the variable k becomes 1 (k=1).

After that, the control unit 10 connects only the module M1 to the bus B1 by using the switch circuit 13 and supplies the lowest power supply voltage VDD1, which is 3.3 V, to the module M1 as a drive voltage by using the level conversion circuit 12 (step S103). As a result, the module M1 can perform an operation for sending back information about its communication specification to the control circuit 11.

Specifically, in the control unit 10, the bus connection control circuit 15 rewrites a value in the register 16 based on an instruction from the control circuit 11. More specifically, as shown in FIG. 7, the bus connection control circuit 15 rewrites the value of the on/off information SW[1][1] for the switch SW disposed between the bus B1 and the module M1 from 0 to 1 (from off to on). Further, the bus connection control circuit 15 rewrites the value of the information VOLB[1] of the drive voltage assigned to the bus B1 from 0 to 1 (3.3 V). Further, the bus connection control circuit 15 rewrites the valued of BPSB[1], which is information about the communication speed assigned to the bus B1, from 0 to 1 (100 kbps).

Then, the switch circuit 13 connects only the module M1 to the bus B1 based on the value in the register 16. Note that the other modules M2 to Mn are not connected to any of the buses B1 to Bm. Further, the level conversion circuit 12 supplies the lowest power supply voltage VDD1, which is 3.3 V, to the module M1 through the bus B1 as a drive voltage based on the value in the register 16. This means that the level conversion circuit 12 supplies a power supply voltage of 3.3 V to each of the communication lines (the power supply line, the signal line SDA, and the signal line SCL) of the bus B1 on the switch circuit 13 side based on the value in the register 16.

Note that when the drive voltage of each of the modules M1 to Mn is known as 3.3 V or 5 V, the level conversion circuit 12 sets the lowest power supply voltage of 3.3 V as an initial value of the drive voltage. In contrast to this, when the drive voltage of each of the modules M1 to Mn is unknown, the level conversion circuit 12 sets, for example, the lowest voltage under the specification as a drive voltage.

After that, the control unit 10 requests information about the drive voltage from the module M1 and acquires the information about the drive voltage sent back from the module M1 through the specification detection circuit 14 (step S104).

More specifically, in the control unit 10, the control circuit 11 outputs an H-level signal to the module M1 through one of the signal lines of the bus B1 (e.g., the signal line SDA). The module M1 has a function of outputting information about its own drive voltage. For example, the module M1 sends back an L-level signal when its drive voltage is 3.3 V and sends back an H-level signal when its drive voltage is 5 V. The specification detection circuit 14 takes in (i.e., receives) the information about the drive voltage (an H- or L-level signal) sent back from the module M1 and delivers it to the control circuit 11.

After that, the control unit 10 supplies the drive voltage to the module M1 based on the acquired information about the drive voltage of the module M1 (step S105).

More specifically, in the control unit 10, the bus connection control circuit 15 rewrites a value in the register 16 based on the information about the drive voltage of the module M1 output from the control circuit 11. For example, when the information about the drive voltage of the module M1 indicates 5 V, the bus connection control circuit 15 rewrites the value of information VOLB[1] of the drive voltage assigned to the bus B1 from 1 (3.3 V) to 2 (5 V) as shown in FIG. 8. Note that when the information about the drive voltage of the module M1 indicates 3.3 V, the value of VOLB[1] is kept unchanged from 1 (3.3 V). Then, the level conversion circuit 12 supplies the drive voltage of 3.3 V or 5 V to the module M1 based on the value in the register 16. This means that the level conversion circuit 12 supplies a power supply voltage of 3.3 V or 5 V to each of the communication lines (the power supply line, the signal line SDA, and the signal line SCL) of the bus B1 on the switch circuit 13 side based on the value in the register 16.

After that, the control unit 10 requests information about a communication speed from the module M1 and acquires the information about the communication speed sent back from the module M1 through the specification detection circuit 14 (step S106).

More specifically, in the control unit 10, the control circuit 11 communicates with the module M1 through the bus B1 at the lowest operable speed (e.g., the lowest speed under the specification) and thereby acquires communication speed information stored in the module M1. Note that as shown in FIG. 7, by rewriting the value of information BPSB[1] of the communication speed assigned to the bus B1 from 0 to 1 (100 kbps) in advance, the control circuit 11 can perform communication at the lowest operable speed.

Note that the control unit 10 may acquire the information about the communication speed of the module M1 by using a method similar to the method for acquiring the information about the drive voltage of the module M1. In such a case, in the control unit 10, the control circuit 11 outputs an H-level signal to the module M1 through one of the signal lines of the bus B1 (e.g., the signal line SDA). The module M1 has a function of outputting information about its own communication speed and, for example, sends back an H- or L-level signal according to the communication speed. The specification detection circuit 14 takes in (i.e., receives) the information about the communication speed (the H- or L-level signal) sent back from the module M1 and delivers it to the control circuit 11.

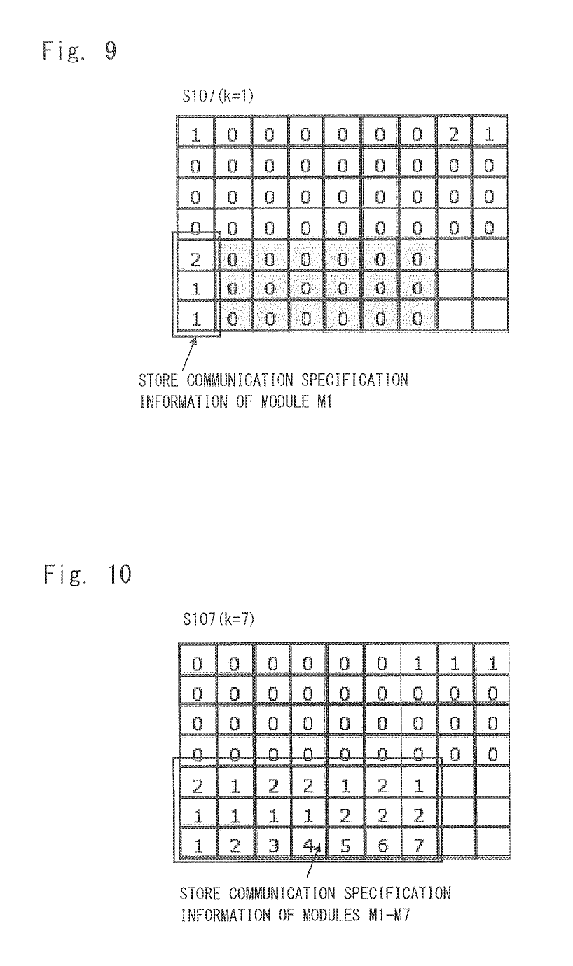

Then, the control unit 10 stores the acquired information about the drive voltage and the communication speed of the module M1, i.e., the acquired information about the communication specification of the module M1 in a storage unit such as the register 16 (step S107). Specifically, as shown in FIG. 9, the values of VOLM[1], BPSM[1], and ID[1] in the register 16 are rewritten by the acquired information about the drive voltage, the communication speed, and the module ID of the module M1. In the example shown in FIG. 9, the values of VOLM[1], BPSM[1], and ID[1] are rewritten to 2 (5 V), 1 (100 kbps), and 1, respectively.

After that, the control unit 10 determines whether or not the variable k is equal to the number n (k=n). When the variable k is not equal to the number n (No at step S108), the control unit 10 counts up the value of the variable k by one again (step S102). Therefore, the variable k becomes 2 (k=2).

After that, the control unit 10 connects only the module M2 to the bus B1 by using the switch circuit 13 (step S103) and supplies the lowest power supply voltage VDD1, which is 3.3 V, to the module M2 as a drive voltage by using the level conversion circuit 12. After that, the control unit 10 requests information about a drive voltage from the module M2 and acquires the information about the drive voltage sent back from the module M2 (step S104). After that, the control unit 10 supplies the drive voltage to the module M2 based on the acquired information about the drive voltage of the module M2 (step S105). After that, the control unit 10 requests information about a communication speed from the module M2 and acquires the information about the communication speed sent back from the module M2 (step S106). Then, the control unit 10 stores the information about the drive voltage and the communication speed of the module M2, i.e., the information about the communication specification of the module M2 in a storage unit such as the register 16 (step S107).

After that, the control unit 10 determines whether or not the variable k is equal to the number n (k=n). When the variable k is not equal to the number n (No at step S108), the control unit 10 counts up the value of the variable k by one again (step S102). Therefore, the variable k becomes 3 (k=3). After that, the series of processes of “NO” in the steps S102 to S108 are repeated until the variable k becomes equal to the number n (k=n).

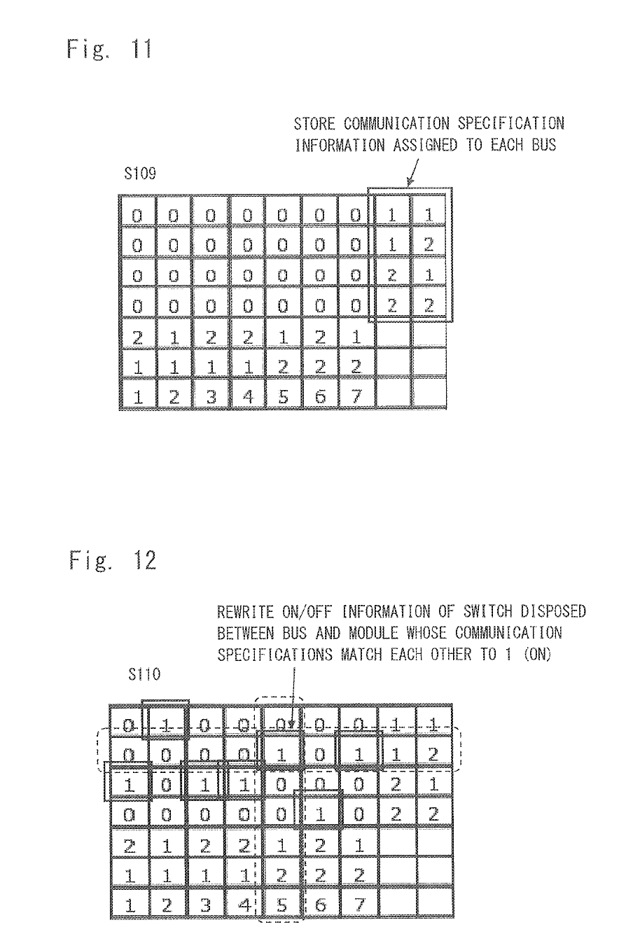

Consequently, as shown in FIG. 10, the values of VOLM[1]-[7], BPSM[1]-[7], and ID[1]-[7] in the register 16 are rewritten by the acquired information about the drive voltages, the communication speeds, and the module IDs of the respective modules M1 to Mn (n=7). That is, the information about the communication specification for each of the modules M1 to Mn is written in the register 16.

When the variable k becomes equal to the number n (k=n) (Yes at step S108), the control unit 10 sets (or establishes) connections between the buses B1 to Bm and the modules M1 to Mn by using the switch circuit 13 based on the acquired information about the communication specifications for the respective modules M1 to Mn, and supplies drive voltages having levels corresponding to the communication specifications for the respective modules M1 to Mn by using the level conversion circuit 12 (steps S109 and S110).

More specifically, the information about the communication specification (a drive voltage and a communication speed), which is stored in the register 16 and assigned to each of the buses B1 to Bm, is rewritten based on the information about the communication specification for each of the corresponding modules M1 to Mn stored in the register 16. As a result, a communication specification is assigned to each of the buses B1 to Bm (step S109).

For example, as shown in FIG. 11, the value of VOLB[1] is rewritten to 1 and the value of BPSB[1] is rewritten to 1. As a result, a communication specification specifying that a drive voltage is 3.3 V and a communication speed is 100 kbps is assigned to the bus B1. Further, the value of VOLB[2] is rewritten to 1 and the value of BPSB[2] is rewritten to 2. As a result, a communication specification specifying that a drive voltage is 3.3 V and a communication speed is 400 kbps is assigned to the bus B2. Further, the value of VOLB[3] is rewritten to 2 and the value of BPSB[3] is rewritten to 1. As a result, a communication specification specifying that a drive voltage is 5 V and a communication speed is 100 kbps is assigned to the bus B3. Further, since the value of VOLB[4] is rewritten to 2 and the value of BPSB[4] is rewritten to 2, a communication specification specifying that a drive voltage is 5 V and a communication speed is 400 kbps is assigned to the bus B4.

After that, the switch circuit 13 connects the modules M1 to Mn to the buses to which their respective communication specifications are assigned (step S110).

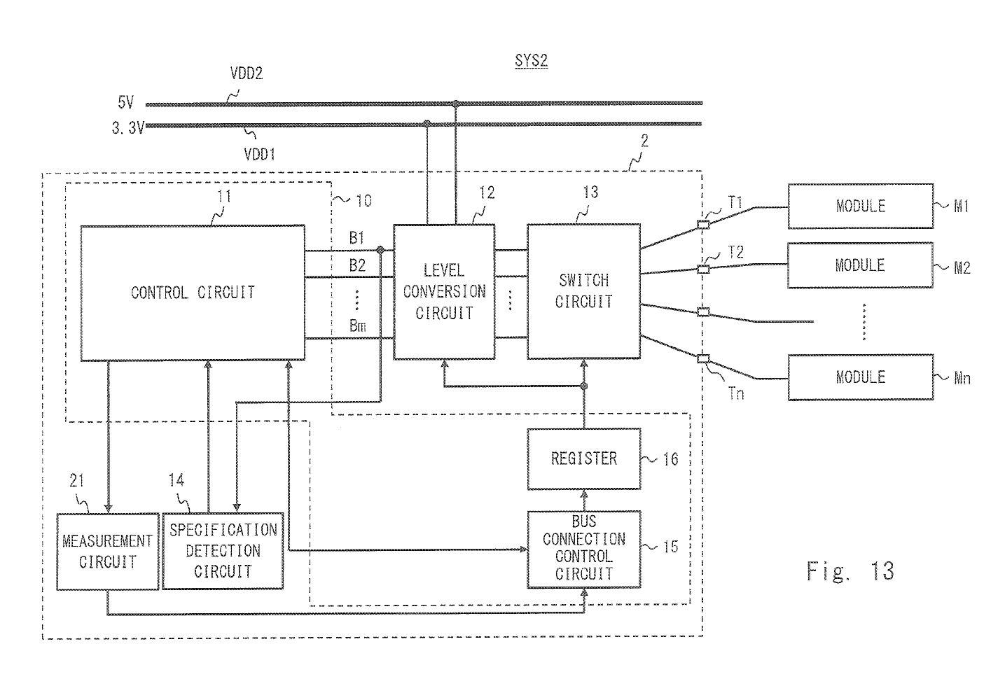

Specifically, as shown in FIG. 12, on/off information for a switch SW disposed between a bus and a module whose communication specifications match each other is rewritten from 0 to 1 (from off to on) in the register 16. Then, the switch circuit 13 connects each of the modules M1 to Mn to a bus to which its communication specification is assigned based on the on/off information for each switch SW stored in the register 16. As a result, a plurality of modules having the same communication speed and the same drive voltage are connected to the same bus. Meanwhile, modules having different communication speeds and/or different drive voltages are connected to different buses. In the example shown in FIG. 12, the module M2 is connected to the bus B1 and the modules M5 and M7 are connected to the bus B2. Further, the modules M1, M3 and M4 are connected to the bus B3 and the module M6 is connected to the bus B4.

Further, the level conversion circuit 12 supplies the drive voltages specified in the communication specifications assigned to the buses B1 to Bm to the switch circuit 13 side of the respective buses B1 to Bm. As a result, for example, a common drive voltage is supplied to a plurality of modules that have the same communication specification and are connected to the same bus.

After that, the semiconductor device 1 starts a normal operation (S111). That is, data communication is started between the control circuit 11 and the modules M1 to Mn.

As described above, the semiconductor device 1 according to this embodiment acquires information about a communication specification including information about a drive voltage from each of a plurality of externally-disposed modules M1 to Mn, sets connections between the modules M1 to Mn and the buses B1 to Bm based on the acquired communication specifications, and then performs data communication with the modules M1 to Mn. The semiconductor device 1 according to this embodiment can connect a plurality of modules having different drive voltages as well as a plurality of modules having different communication speeds to the control circuit 11 at the same time, thus making it possible to simultaneously control a plurality of modules having difference drive voltages and/or different communication speeds by using one control circuit (i.e., the control circuit 11). That is, it is possible to improve flexibility in design.

Note that this embodiment is explained by using an example case in which when the communication specification information of each of the modules M1 to Mn is acquired, one of the modules M1 to Mn is connected only to the bus B1. However, the module may be connected to a bus other than the bus B1. Further, when the amount of information about a communication specification is large, the communication specification information may be acquired by using a plurality of signal lines SCL and SDA of the bus B1.

The control unit 10 may have a function of performing control so that the number of modules connected to each of the buses B1 to Bm is equal to or less than a predetermined number. By doing so, the communication time can be reduced.

### Second Embodiment

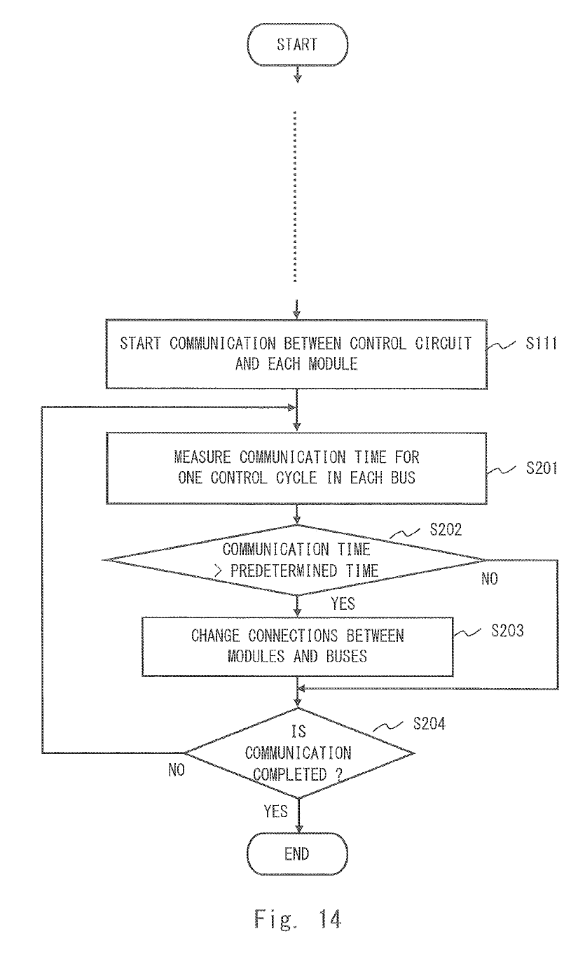

FIG. 13 is a block diagram showing a configuration of a semiconductor system SYS2 including a semiconductor device 2 according to a second embodiment. Compared to the semiconductor device 1, the semiconductor device 2 further includes a measurement circuit 21. The configurations of the semiconductor device 2 and the semiconductor system SYS2 including the semiconductor device 2 are similar to those of the semiconductor device 1 and the semiconductor system SYS1 including the semiconductor device 1, and therefore their explanations are omitted.

The measurement circuit 21 is a circuit that measures the time of communication in each of the buses B1 to Bm. For example, the measurement circuit 21 measures (i.e., obtains) the sum total of communication times for one control cycle (a predetermined cycle) in each of the buses B1 to Bm.

Based on a result obtained in the measurement circuit 21, the control unit 10 re-connects one of a plurality of modules connected to a bus whose sum total of communication times for one control cycle exceeds a specified time to one of the other buses. By doing so, the communication time can be reduced. Note that the above-described process may be periodically performed after a normal operation is started, or may be performed during a connection setting operation that is performed before the normal operation.

For example, in the case where three modules M1 to M3 having the same communication specification are connected to the bus B1, when the sum total of communication times for one control cycle in the bus B1 exceeds the specified time, the control unit 10 re-connects one of the modules M1 to M3 to one of the other buses to which no module is connected. Alternatively, when there is a module whose communication speed can be lowered among the modules M1 to M3, that module is re-connected to one of the other buses to which a module having a lower communication speed and the same drive voltage is connected.

Note that the number of modules connected to the same bus can be determined based on the on/off information for each switch SW stored in the register 16. For example, the number of modules connected to the bus B1 can be determined based on the on/off information for switch SWs stored in storage areas in (1st row)×(1st to nth columns) (i.e., SW[1][1] to SW[1][n]) in the register 16 shown in FIG. 2.

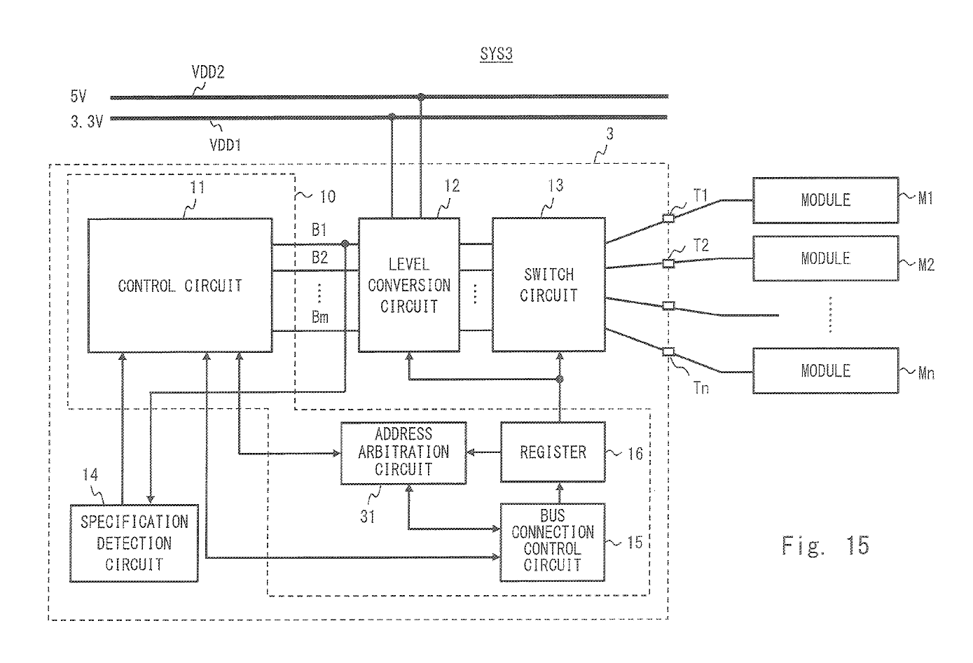

FIG. 14 is a flowchart showing a connection setting operation performed by the semiconductor device 2. Note that processes in steps S101 to S111 are similar to those shown in FIG. 6 and therefore their explanations are omitted.

As shown in FIG. 14, when data communication is started between the control circuit 11 and the modules M1 to Mn (step S111), the measurement circuit 21 measures (i.e., obtains) the sum total of communication times for one control cycle (a predetermined cycle) in each of the buses B1 to Bm (step S201).

The control unit 10 determines whether or not there is a bus whose sum total of communication times for one control cycle exceeds a specified time (step S202). When there is no bus whose sum total of communication times for one control cycle exceeds the specified time (No at step S202), the control unit 10 does not change the connections between the modules and the buses. On the other hand, when there is a bus whose sum total of communication times for one control cycle exceeds the specified time (Yes at step S202), the control unit 10 changes the connections between the modules and the buses (step S203). Specifically, the control unit 10 re-connects one of a plurality of modules connected to a bus whose sum total of communication times for one control cycle exceeds the specified time to one of the other buses.

After that, when the data communication has not been completed yet (No at step S204), the process returns to the periodic measurement process performed by the measurement circuit 21 (step S201). On the other hand, when the data communication has been already completed (Yes at step S204), the operation is finished.

As described above, in addition to providing an advantageous effect similar to that of the semiconductor device 1, the semiconductor device 2 according to this embodiment can reduce the communication time by re-connecting one of a plurality of modules connected to a bus whose sum total of communication times for one control cycle exceeds the specified time to one of the other buses.

### Third Embodiment

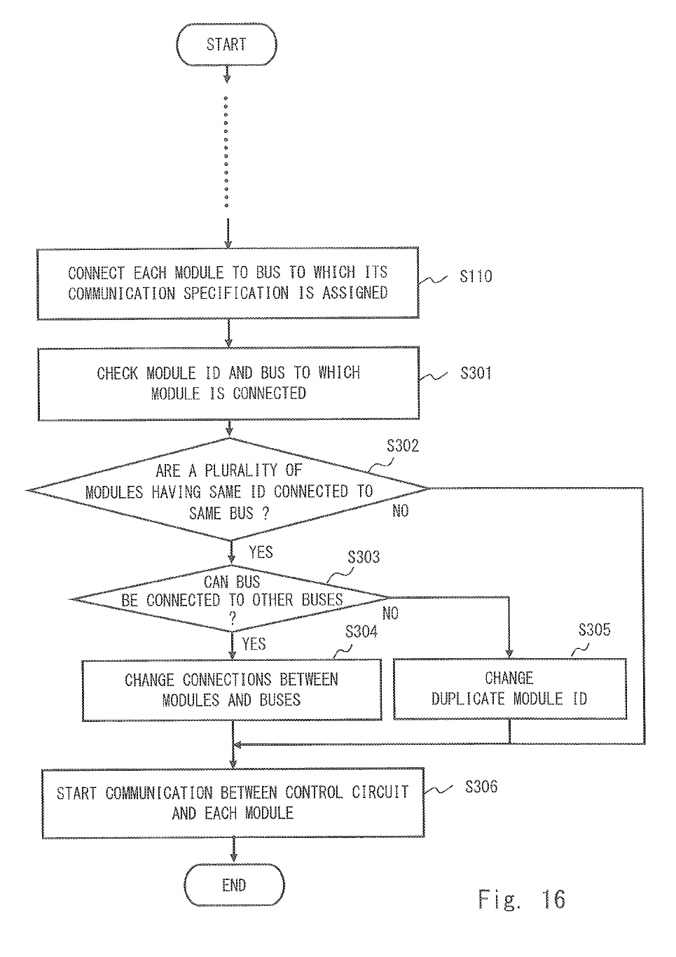

FIG. 15 is a block diagram showing a configuration of a semiconductor system SYS3 including a semiconductor device 3 according to a third embodiment. Compared to the semiconductor device 1, the semiconductor device 3 further includes an address arbitration circuit 31. Note that the control circuit 11, the bus connection control circuit 15, the register 16, and the address arbitration circuit 31 form the control unit (controller) 10. The configurations of the semiconductor device 3 and the semiconductor system SYS3 including the semiconductor device 3 are similar to those of the semiconductor device 1 and the semiconductor system SYS1 including the semiconductor device 1, and therefore their explanations are omitted.

The address arbitration circuit 31 is a circuit that monitors IDs of the modules M1 to Mn and connects a plurality of modules having the same ID to different buses.

FIG. 16 is a flowchart showing a connection setting operation performed by the semiconductor device 3. Note that processes in steps S101 to S110 are basically similar to those shown in FIG. 6 and therefore their explanations are omitted. However, the control unit 10 also acquires IDs of the modules M1 to Mn when it acquires the information about communication speeds of the modules M1 to Mn (step S106). Note that in the case of the I2C communication, the ID of a module means a slave address thereof.

As shown in FIG. 16, after the modules M1 to Mn are connected to buses to which their respective communication specifications are assigned (step S110), the address arbitration circuit 31 checks an ID of each of the modules M1 to Mn and a bus to which that module is connected (step S301).

When any two or more modules having the same ID are not connected to the same bus (No at step S302), data communication is started between the control circuit 11 and the modules M1 to Mn without changing the connections between the modules and the buses (step S306).

On the other hand, when a plurality of modules having the same ID are connected to the same bus (Yes at step S302), the address arbitration circuit 31 determines whether or not the plurality of modules having the same ID can be connected to different buses from each other (step S303).

Note that the determination whether or not a plurality of modules having the same ID are connected to the same bus can be made based on module ID information (ID[1] to ID[n] in FIG. 2) of the plurality of modules connected to the same bus.

When the plurality of modules having the same ID can be connected to different buses from each other (Yes at step S303), the address arbitration circuit 31 re-connects these modules to different buses from each other (step S304). On the other hand, when the plurality of modules having the same ID cannot be connected to different buses from each other (No at step S303), the IDs of these modules are changed to different IDs from each other (step S305).

After that, the semiconductor device 3 starts a normal operation (S306). That is, data communication is started between the control circuit 11 and the modules M1 to Mn.

As described above, in addition to providing an advantageous effect similar to that of the semiconductor device 1, the semiconductor device 3 according to this embodiment can prevent the collision of IDs, even when there are a number of modules, by connecting a plurality of modules having the same ID to different buses from each other by using the address arbitration circuit 31.

Note that the semiconductor device 3 may include the above-described measurement circuit 21 in addition to the address arbitration circuit 31.

As described above, a semiconductor device according to any one of the above-described first to third embodiments acquires information about a communication specification including information about a drive voltage from each of a plurality of externally-disposed modules M1 to Mn, sets connections between the modules M1 to Mn and the buses B1 to Bm based on the acquired communication specifications, and then performs data communication with the modules M1 to Mn. The semiconductor device according to any one of the above-described first to third embodiments can connect a plurality of modules having different drive voltages as well as a plurality of modules having different communication speeds to the control circuit 11 at the same time, thus making it possible to simultaneously control a plurality of modules having difference drive voltages and/or different communication speeds by using one control circuit (i.e., the control circuit 11). That is, it is possible to improve flexibility in design.

The present invention made by the inventors has been explained above in a specific manner based on embodiments. However, the present invention is not limited to the above-described embodiments, and needless to say, various modifications can be made without departing from the spirit and scope of the present invention.

For example, the semiconductor device according to the above-described embodiment may have a configuration in which the conductivity type (p-type or n-type) of the semiconductor substrate, the semiconductor layer, the diffusion layer (diffusion region), and so on may be reversed. Therefore, when one of the n-type and p-type is defined as a first conductivity type and the other is defined as a second conductivity type, the first and second conductivity types may be the p-type and n-type, respectively. Alternatively, the first and second conductivity types may be the n-type and p-type, respectively.

The whole or part of the embodiments disclosed above can be described as, but not limited to, the following supplementary notes.

(Supplementary note 1)

A semiconductor device comprising:

a plurality of buses; a control unit connected to the plurality of buses, the control unit being configured to acquire information about a communication specification including information about a drive voltage from each of a plurality of externally-disposed modules through one of the plurality of buses; and

a switch circuit configured to set a connection between the plurality of modules and the plurality of buses based on the information about the communication specification for each of the plurality of modules acquired by the control unit.

(Supplementary note 2)

The semiconductor device described in Supplementary note 1, further comprising a measurement circuit configured to measure a communication time in each of the plurality of buses, wherein

the control circuit sets a connection between the plurality of modules and the plurality of buses by using the switch circuit so that a sum total of a communication time per predetermined cycle in each of the plurality of buses is equal to or less than a specified time.

### REFERENCE SIGNS LIST

1 SEMICONDUCTOR DEVICE
2 SEMICONDUCTOR DEVICE
3 SEMICONDUCTOR DEVICE
10 CONTROL UNIT
11 CONTROL CIRCUIT
12 LEVEL CONVERSION CIRCUIT
13 SWITCH CIRCUIT
14 SPECIFICATION DETECTION CIRCUIT
15 BUS CONNECTION CONTROL CIRCUIT
16 REGISTER
21 MEASUREMENT CIRCUIT
31 ADDRESS ARBITRATION CIRCUIT
BF1 BUFFER
INV1 INVERTER
MN1 TRANSISTOR
MP1 TRANSISTOR
MP2 TRANSISTOR
M1-Mn MODULE
R1 RESISTIVE ELEMENT
R2 RESISTIVE ELEMENT
SYS1 SEMICONDUCTOR SYSTEM
SYS2 SEMICONDUCTOR SYSTEM
SYS3 SEMICONDUCTOR SYSTEM
SW SWITCH
T1-Tn CONNECTOR
VDD1 POWER SUPPLY
VDD2 POWER SUPPLY

1. A semiconductor device comprising:
a plurality of buses;
a control unit connected to the plurality of buses, the control unit being configured to acquire information about a communication specification including information about a drive voltage from each of a plurality of externally-disposed modules through one of the plurality of buses; and
a switch circuit configured to set a connection between the plurality of modules and the plurality of buses based on the information about the communication specification for each of the plurality of modules acquired by the control unit.

2. The semiconductor device according to claim 1, further comprising a level conversion circuit configured to supply drive voltages to the plurality of modules, the drive voltages having levels corresponding to the communication specifications of the respective modules, the level conversion circuit being further configured to convert a level of a signal propagating between the control unit and the plurality of modules.

3. The semiconductor device according to claim 1, wherein the switch circuit connects, among the plurality of modules, a plurality of modules having the same communication speed and the same drive voltage to the same bus among the plurality of buses.

4. The semiconductor device according to claim 1, wherein
the control unit includes a register configured to store information about the communication specification for each of the plurality of modules, and
the switch circuit sets a connection between the plurality of modules and the plurality of buses based on a value stored in the register.

5. The semiconductor device according to claim 4, wherein
the register stores:
information about communication specifications each of which is generated based on information about the communication specification of a respective one of the plurality of modules and is assigned to a respective one of the plurality of buses; and
connection information for a connection between a bus and a module whose communication specifications match each other, and
the switch circuit sets a connection between the plurality of modules and the plurality of buses based on the connection information stored in the register.

6. The semiconductor device according to claim 1, further comprising a measurement circuit configured to measure a communication time in each of the plurality of buses, and
the control unit re-connects one of a plurality of modules connected to a bus whose sum total of a communication time per predetermined cycle exceeds a specified time to another bus by using the switch circuit.

7. The semiconductor device according to claim 6, wherein the control unit re-connects one of a plurality of modules connected to a bus whose sum total of a communication time per predetermined cycle exceeds the specified time to another bus to which no module is connected by using the switch circuit.

8. The semiconductor device according to claim 6, wherein the control unit re-connects one of a plurality of modules connected to a bus whose sum total of a communication time per predetermined cycle exceeds the specified time to another bus to which a module having a lower communication speed and the same drive voltage is connected by using the switch circuit.

9. The semiconductor device according to claim 1, wherein the control unit sets a connection between the plurality of modules and the plurality of buses by using the switch circuit so that the number of modules connected to each of the plurality of buses is equal to or less than a predetermined number.

10. The semiconductor device according to claim 1, wherein the control unit sets a connection between the plurality of modules and the plurality of buses by using the switch circuit so that IDs of all of a plurality of modules connected to each of the plurality of buses are different from each other.

11. A semiconductor system comprising:
a semiconductor device according to claim 1; and
the plurality of modules, each of the plurality of modules being configured to sending back information about the communication specification in response to a request sent from the control unit.

12. A control method for a semiconductor device, comprising:
acquiring information about a communication specification including information about a drive voltage from each of a plurality of externally-disposed modules;
setting a connection between the plurality of modules and a plurality of buses based on the communication specification for each of the plurality of modules; and
performing data communication with the plurality of modules through the plurality of buses.

13. The control method for a semiconductor device according to claim 12, further comprising supplying drive voltages to the plurality of modules, the drive voltages having levels corresponding to the communication specifications of the respective modules, wherein
data communication is performed with the plurality of modules through the plurality of buses while converting a level of a signal received from the plurality of modules and a level of a signal to be transmitted to the plurality of modules.

14. The control method for a semiconductor device according to claim 12, wherein among the plurality of modules, a plurality of modules having the same communication speed and the same drive voltage are connected to the same bus among the plurality of buses.

15. The control method for a semiconductor device according to claim 12, wherein one of a plurality of modules connected to a bus whose sum total of a communication time per predetermined cycle exceeds a specified time is re-connected to another bus.

16. The control method for a semiconductor device according to claim 15, wherein one of a plurality of modules connected to a bus whose sum total of a communication time per predetermined cycle exceeds a specified time is re-connected to another bus to which no module is connected.

17. The control method for a semiconductor device according to claim 15, wherein one of a plurality of modules connected to a bus whose sum total of a communication time per predetermined cycle exceeds a specified time is re-connected to another bus to which a module having a lower communication speed and the same drive voltage is connected.

18. The control method for a semiconductor device according to claim 12, wherein a connection between the plurality of modules and the plurality of buses is set so that a sum total of a communication time per predetermined cycle in each of the plurality of buses is equal to or less than a specified time.

19. The control method for a semiconductor device according to claim 12, wherein a connection between the plurality of modules and the plurality of buses is set so that the number of modules connected to each of the plurality of buses is equal to or less than a predetermined number.

20. The control method for a semiconductor device according to claim 12, wherein a connection between the plurality of modules and the plurality of buses is set so that IDs of all of a plurality of modules connected to each of the plurality of buses are different from each other.
